(19) United States
(12) Patent Application Publication
(10) Pub. No.: US 2021/0171790 A1
(43) Pub. Date: Jun. 10, 2021

(54) TEXTILE PRINTING

(71) Applicant: Hewlett-Packard Development Company, L.P., Spring, TX (US)

(72) Inventors: Zhang-Lin ZHOU, San Diego, CA (US); Qianhan YANG, San Diego, CA (US)

(73) Assignee: Hewlett-Packard Development Company, L.P., Spring, TX (US)

(21) Appl. No.: 17/265,861

(22) PCT Filed: Nov. 13, 2018
(86) PCT No.: PCT/US2018/060606

§ 371 Date: Feb. 4, 2021

(51) Int. Cl. C09D 11/322; C09D 11/107; C09D 11/102; C09D 11/033; C09D 11/037; B41J 11/00; B41M 5/00; B41M 7/00; D06P 5/30; D06P 5/20; D06P 1/52

(52) U.S. Cl. CPC C09D 11/322; C09D 11/107; C09D 11/102; C09D 11/033; C09D 11/037; B41J 11/002; D06P 1/5257; B41M 7/009; B41M 5/0047; D06P 5/30; D06P 5/2077; D06P 1/5285; B41M 5/0023

(57) ABSTRACT

A textile printing system includes an ink composition and a fabric substrate. The ink composition includes from 50 wt % to 95 wt % water, from 4 wt % to 49 wt % organic cosolvent, from 0.5 wt % to 12 wt % pigment with a dispersant associated with a surface thereof, and from 0.5 wt % to 20 wt % polyurethane-latex hybrid particles. The polyurethane-latex hybrid particles include a polyurethane shell having an acid number from 50 mg KOH/g to 110 mg KOH/g and a (meth)acrylic latex core having a glass transition temperature from −30° C. to 50° C. A weight ratio of polyurethane shell to (meth)acrylic latex core is from 1:19 to 3:7 in this example.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF DRAWINGS

FIG. 1 schematically depicts an example textile printing system including an ink composition and a fabric substrate in accordance with the present disclosure;

FIG. 2 schematically depicts an example textile printing system including an ink composition, a fabric substrate, an inkjet printhead, and a heat curing device in accordance with the present disclosure;

FIG. 3 schematically depicts an example of the preparation of polyurethane-latex hybrid particles in accordance with the present disclosure; and

FIG. 4 provides a flow diagram for an example method of printing textiles in accordance with the present disclosure.

### DETAILED DESCRIPTION

The present technology relates to printing on fabric using pigmented ink composition in textile printing systems and methods. In one example, a textile printing system includes an ink composition and a fabric substrate. The ink composition includes from 50 wt % to 95 wt % water, from 4 wt % to 49 wt % organic co-solvent, from 0.5 wt % to 12 wt % pigment with a dispersant associated with a surface thereof, and from 0.5 wt % to 20 wt % polyurethane-latex hybrid particles. The polyurethane-latex hybrid particles include a polyurethane shell having an acid number from 50 mg KOH/g to 110 mg KOH/g and a (meth)acrylic latex core having a glass transition temperature from −30° C. to 50° C. The weight ratio of polyurethane shell to (meth)acrylic latex core is from 1:19 to 3:7 in this example. In one example, the polyurethane shell includes isocyanate-generated amine groups along a backbone of the polyurethane. In another example, the polyurethane-latex hybrid particles can have a D50 particle size from 50 nm to 150 nm. The polyurethane-latex hybrid particles can have a weight ratio of polyurethane shell to (meth)acrylic latex core from 1:9 to 1:4. The (meth)acrylic latex core can have an acid number from 0 mg KOH/g to less than 50 mg KOH/g, and/or the polyurethane shell can have an acid number from 85 mg KOH/g to 110 mg KOH/g. The (meth)acrylic latex core can be uncrosslinked, for example. The (meth)acrylic latex core can have a weight average molecular weight of 50,000 Mw to 750,000 Mw. Furthermore, the (meth)acrylic latex core can include copolymerized acrylic amides, copolymerized diacrylates, or a combination thereof. The polyurethane-latex hybrid particles can have a glass transition temperature from −15° C. to 65° C. The fabric substrate can include cotton, polyester, nylon, silk, or a blend thereof.

In another example, a method of textile printing includes ejecting an ink composition onto a fabric substrate, wherein the ink composition includes from 50 wt % to 95 wt % water, from 4 wt % to 49 wt % organic co-solvent, from 0.5 wt % to 12 wt % pigment with a dispersant associated with a surface thereof, and from 0.5 wt % to 20 wt % polyurethane-latex hybrid particles. The polyurethane-latex hybrid particles includes a polyurethane shell having an acid number from 50 mg KOH/g to 110 mg KOH/g and a (meth)acrylic latex core having a glass transition temperature from −30° C. to 50° C. A weight ratio of polyurethane shell to (meth)acrylic latex core is from 1:19 to 3:7 in this example. In one example, the polyurethane-latex hybrid particles can have a D50 particle size from 50 nm to 150 nm, a weight ratio of polyurethane shell to (meth)acrylic latex core from 1:9 to 1:4, and/or the polyurethane shell can have an acid number from 85 mg KOH/g to 110 mg KOH/g. The method can further include curing the ink composition on the fabric substrate at a temperature from 100° C. to 200° C. for from 30 seconds to 5 minutes.

In another example, a textile printing system includes a fabric substrate, an inkjet printer to eject an ink composition on the fabric substrate, and a heat curing device to apply heat to the ink composition after application onto the fabric substrate. The ink composition includes from 50 wt % to 95 wt % water, from 4 wt % to 49 wt % organic co-solvent, from 0.5 wt % to 12 wt % pigment with a dispersant associated with a surface thereof, and from 0.5 wt % to 20 wt % polyurethane-latex hybrid particles. The polyurethane-latex hybrid particles include a polyurethane shell having an acid number from 50 mg KOH/g to 110 mg KOH/g and a (meth)acrylic latex core having a glass transition temperature from −30° C. to 50° C. A weight ratio of polyurethane shell to (meth)acrylic latex core is from 1:19 to 3:7 in this example. In one specific example, the heat curing device can be to apply heat a temperature from 100° C. to 200° C. for a period of 30 seconds to 5 minutes can also be included.

It is noted that when discussing the textile printing systems or the methods of textile printing herein, these discussions can be considered applicable to one another whether or not they are explicitly discussed in the context of that example. Thus, for example, when discussing an organic co-solvent related to the textile printing systems, such disclosure is also relevant to and directly supported in the context of the methods of textile printing, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

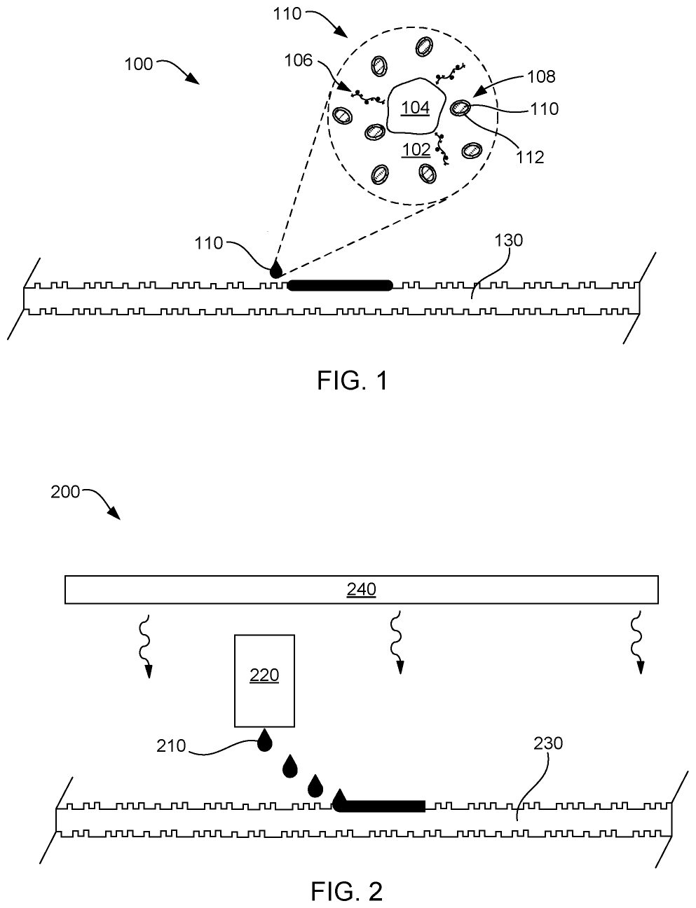

Turning now to more specific detail regarding the textile printing systems, in FIG. 1, an example textile printing system 100 is shown which includes a fabric substrate 130 and an ink composition 110. The ink composition includes water and organic co-solvent (shown collectively as liquid vehicle 102, pigment 104 with dispersant 106 associated with a surface of the pigment. The ink composition also includes polyurethane-latex hybrid particles 108. Thus, the polyurethane-latex hybrid particles include multiple types of polymer, namely a (meth)acrylic latex core 110 and a polyurethane shell 112. The dispersant can be associated with the pigment by adsorption, ionic attraction, or by covalent attachment thereto.

In another example, an example textile printing system, shown at 200 in FIG. 2, can include a fabric substrate 230, an ink composition 210, an inkjet printhead 220, such as a thermal inkjet printhead to thermally eject the ink composition on the fabric substrate, and a heat curing device 240 to heat the ink composition after application onto the fabric substrate. The ink composition in this example includes water, organic co-solvent, pigment having a dispersant associated with a surface thereof, and polyurethane-latex hybrid particles. The polyurethane-latex hybrid particles and other components can be as described in FIG. 1, for example, or hereinafter. The heat curing device can crosslink, for example, the polyurethane shell of the polyurethane-latex hybrid particles including at the isocyanate-generated amine groups, for example. In another example, the heat curing device to heat the fabric substrate after the ink composition is printed thereon can be heated to a temperature from 100° C. to 200° C. for a period of 30 seconds to 5 minutes.

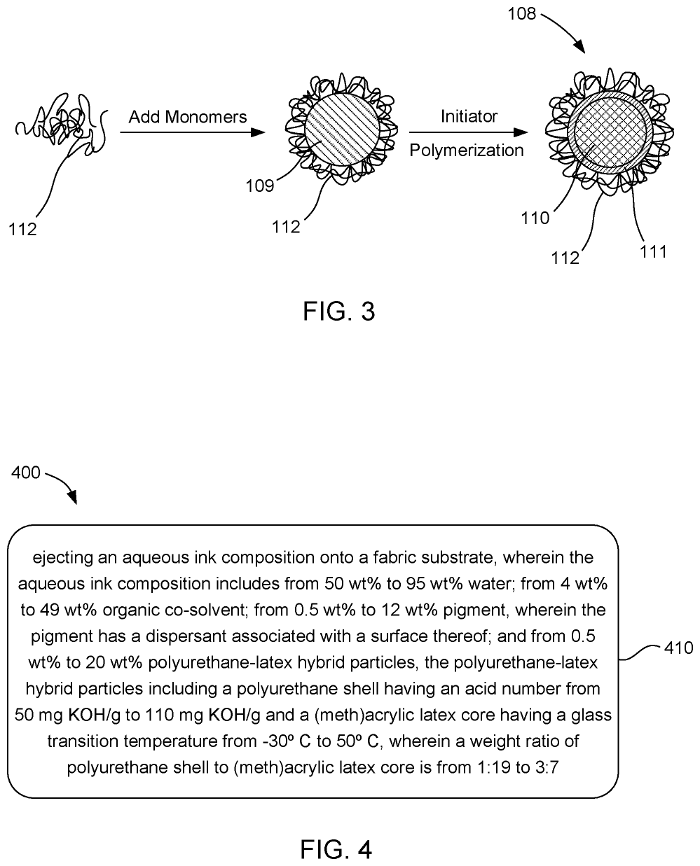

Preparation of the polyurethane-latex hybrid particles can be carried out as shown by way of example in FIG. 3. In this example, the polyurethane 112 polymer can be prepared initially and then the monomers 109 or the (meth)acrylic latex polymer can be copolymerized in the presence of the polyurethane. Surfactant can be used in some examples, but in other examples, surfactant can be omitted because the polyurethane can have properties that allow it to act as an emulsifier for the emulsion polymerization reaction. Initiator can then be added to start the polymerization process, resulting in the polyurethane-latex hybrid particles 108, which includes a (meth)acrylic latex core 110, a polyurethane shell, and in further detail, there may also be a hybrid zone therebetween where the polyurethane and latex polymer may co-exist.

With more specific reference to the polyurethane shell, the polyurethane can include, in one example, sulfonated- or carboxylated-amine groups, e.g., including monoamines and polyamines such as diamines, and isocyanate-generated amine groups, e.g., amino groups and/or secondary amine groups generated by molar excess of isocyanate groups not used in forming the polymer precursor. In certain examples, sulfonated- or carboxylated-amine groups can be a sulfonated- or carboxylated-aliphatic diamine groups, isocyanate-generated amine groups, and/or nonionic diamine groups.

With respect to amines that are described as “aliphatic,” these amines can be monoamine, diamine, or other polyamine groups that can also include straight-chain alkyl groups, branched-chain alkyl groups, or alicyclic groups, e.g., saturated C2 to C16 aliphatic groups, such as alkyl groups, alicyclic groups, combinations of alkyl and alicyclic groups. Example combinations can include straight-chain alkyl, branched-chain alkyl, alicyclic, branched-chain alkyl alicyclic, straight-chain alkyl alicyclic, alicyclic with multiple alkyl side chains, etc. With respect to amines described as “aromatic,” it is noted that they can include any of a number of aromatic moieties in addition to the amine group(s), and can further include methyl groups or aliphatic moieties as defined above. These definitions of “aliphatic” and “aromatic” with respect to the amines can be used can be related to both the sulfonated- or carboxylated-amines or the nonionic amines described herein.

With respect to the “isocyanate-generated amine” groups, these types of groups can refer to amino or secondary amine groups that can be generated from excess isocyanate (NCO) groups that are not utilized when forming the polymer precursor. Thus, upon reacting with water (rather than being used to form the polymer backbone with a diol) the excess isocyanate groups release carbon dioxide, leaving an amine group where the isocyanate group was previously present. Thus, these amine groups are generated by the reaction of excess isocyanate groups with water to leave the isocyanate-generated amine groups, which can be along the polymer backbone, for example.

The “nonionic diamine” groups can likewise be present and reacted with a polymer precursor to form nonionic diamine groups as pendant side chains. These can also be aliphatic diamine groups. As mentioned in the context of the sulfonated- or carboxylated-amine groups, the term “aliphatic” refers to C2 to C16 aliphatic groups that can be saturated, but includes unsaturated aliphatic groups as well. Thus, the term “aliphatic” can be used similarly in the context of the nonionic diamine groups, and can include, for example, alkyl groups, alicyclic groups, combinations of alkyl and alicyclic groups, etc., and can include from C2 aliphatic to C16 aliphatic, e.g., straight-chain alkyl, branched alkyl, alicyclic, branched alkyl alicyclic, straight-chain alkyl alicyclic, alicyclic with multiple alkyl side chains, etc.

In further detail, the polyurethane shell, in one example, can include polyester polyurethane moieties. In still another example, the polyurethane shell can also further include a carboxylate group coupled directly to a polymer backbone of the polyurethane shell. Thus, in addition to a diol that may be used to react with the isocyanate groups to form the urethane linkages, a carboxylated diol may likewise be used to react with the diisocyanates to add carboxylated acid groups along a backbone of the polyurethane polymer of the polyurethane shell.

In further detail, as mentioned, there can be various types of amine groups present on the polyurethane shell, namely sulfonated- or carboxylated-alky diamine groups, isocyanate-generated amine groups, and nonionic diamine groups, for example. In one example, the isocyanate-generated amine groups can be present on the polyurethane shell at from 2 wt % to 8 wt % compared to a total weight polyurethane shell. In further detail, however, there can also be a third type of amine group present on the polyurethane shell, namely a nonionic diamine appended to the polyurethane shell.

As mentioned, the polyurethane shell can include multiple amines from various sources. For example, the polyurethane can include sulfonated- or carboxylated-amine groups as well as isocyanate-generated amine groups. The sulfonated- or carboxylated alky diamine groups can be reacted with a polymer precursor, resulting in some examples as a pendant side chain with one of the amine groups attaching the pendant side chain to a polymer backbone and the other amine group and sulfonate or carboxylate group being present along the pendant side chain. The isocyanate-generated amino group, on the other hand, can be generated from excess isocyanate (NCO) groups that are not utilized when forming the polymer precursor, as also mentioned. In further detail, however, there can also be a third type of amine present on the polyurethane shell of the present disclosure. In some examples, in addition to the sulfonated- or carboxylated-amine groups described above, and in addition to the isocyanate-generated amine groups, nonionic diamine groups can also be reacted with the polymer precursor to form nonionic diamine groups as pendant side chains. As mentioned in the context of the sulfonated- or carboxylated-amine groups, the term “aliphatic” refers to C2 to C16 aliphatic groups that can be saturated, but includes unsaturated aliphatic groups as well. Thus, the term “aliphatic” can be used similarly in the context of the nonionic diamine groups, and can include, for example, alkyl groups, alicyclic groups, combinations of alkyl and alicyclic groups, etc., and can include from C2 aliphatic to C16 aliphatic, e.g., straight-chain alkyl, branched alkyl, alicyclic, branched alkyl alicyclic, straight-chain alkyl alicyclic, alicyclic with multiple alkyl side chains, etc.

The polyurethane used to form the shell can have a D50 particle size from 5 nm to 100 nm, from 10 nm to 70 nm, or from 10 nm to 50 nm, for example. The weight average molecular weight can be from 1,000 Mw to 50,000 Mw, from 2,000 Mw to 40,000 Mw, or from 3,000 Mw to 30,000 Mw. The acid number of the polyurethane can be from 50 mg KOH/g to 110 mg KOH/g, from 65 mg KOH/g to 110 mg KOH/g, or from 85 mg KOH/g to 110 mg KOH/g, for example. In further detail, the isocyanate group (NCO) to hydroxyl group (OH) molar ratio when forming the polyurethane can be such that there are excess NCO groups compared to the OH groups, such as provided by diols that may be used to form the polyurethane polymer. Thus, upon interaction with water, the excess NCO groups can liberate carbon dioxide and leave behind a secondary amine or an amino group which can participate in self-crosslinking, for example. Thus, in certain examples, the NCO to OH molar ratio can be from 1.1:1 to 1.5:1, from 1.15:1 to 1.45:1, or from 1.25 to 1.45.

As an example, in preparation of the polyurethane polymer used to form the shell in the systems and methods of the present disclosure, multiple steps can be carried out to prepare the particles, including pre-polymer synthesis which includes reaction of a diisocyanate with polymeric diol. The reaction can occur in the presence of a catalyst in acetone under reflux to give the pre-polymer, in one example. Other reactants may also be used in certain specific examples, such as organic acid diols (in addition to the polymeric diols) to generate acidic moieties along the backbone of the polyurethane polymer. The pre-polymer can be prepared with excess isocyanate groups that compared the molar concentration of the alcohol groups found on the polymeric diols or other diols that may be present. By retaining excess isocyanate groups, in the presence of water, the isocyanate groups can generate amino groups or secondary amines along the polyurethane chain, releasing carbon dioxide as a byproduct. This reaction can occur at the time of chain extension during the process of forming the polyurethane. Once the pre-polymer is formed, the polyurethane polymer used to form the shell can be generated by reacting the pre-polymer with a carboxylated- or sulfonated-amines, and in some examples, also with nonionic diamines. Thus, the polyurethane can be crosslinked and can also include self-crosslinkable moieties. After formation, the solvent can then be removed by vacuum distillation, for example.

Example diisocyanates that can be used to prepare the pre-polymer include 2,2,4 (or 2,4,4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexan (H12MDI), etc., or combinations thereof, as shown below. Others can likewise be used alone, or in combination with these diisocyanates, or in combination with other diisocyanates not shown.

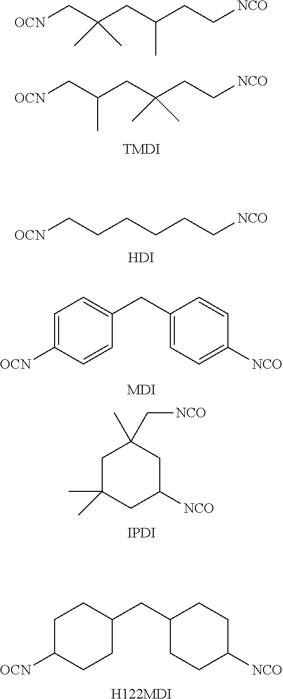

With respect to the polymeric diols that can be used, in one example, the polymeric diol can be a polyester diol, and in another example, the polymeric diol can be a polycarbonate diol, for example. Other diols that can be used include polyether diols, or even combination diols, such as would form a polycarbonate ester polyether-type polyurethane.

With respect to the various amines that can be used in forming the polyurethane as described herein, as mentioned, sulfonated- or carboxylated-amines as well as nonionic diamines can be used. Sulfonated- or carboxylated-amines can be prepared from diamines by adding carboxylate or sulfonate groups thereto. Nonionic diamines can be diamines that include aliphatic groups that are not charged, such as alkyl groups, alicyclic groups, etc. A charged diamine is not used for the nonionic diamine, if present. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc, oxalyl dihydrazides, azelaic dihydrazides, carbohydrazide, etc. It is noted however that these examples may not be appropriate for use for one or the other type of diamine, but rather, this list is provided as being inclusive of the types of diamines that can be used in forming sulfonated- or carboxylated-diamines and/or the non-ionic diamines, and not both in every instance (though some can be used for either type of diamine).

Example diamine structures are shown below. More specific examples of diamines include 4,4′-methylenebis(2-methylcyclohexyl-amine) (DMDC), 4-methyl-1,3′-cyclohexanediamine (HTDA), 4,4′-Methylenebis(cyclohexylamine) (PACM), isphorone diamine (IPDA), tetramethylethylenediamine (TMDA), ethylene diamine (DEA), 1,4-cyclohexane diamine, 1,6-hexane diamine, hydrazine, adipic acid dihydrazide (AAD), carbohydrazide (CHD), and/or diethylene triamine (DETA), notably, DETA includes three amine groups, and thus, is a triamine. However, since it also includes 2 amines, it is considered to fall within the definition herein of “diamine,” meaning it includes two amine groups. Many of the diamine structures shown below can be used as a nonionic diamine, such as the uncharged aliphatic diamines shown below. Likewise, many or all of the diamines shown below can be sulfonated or carboxylated for use as a sulfonated- or carboxylated-diamine.

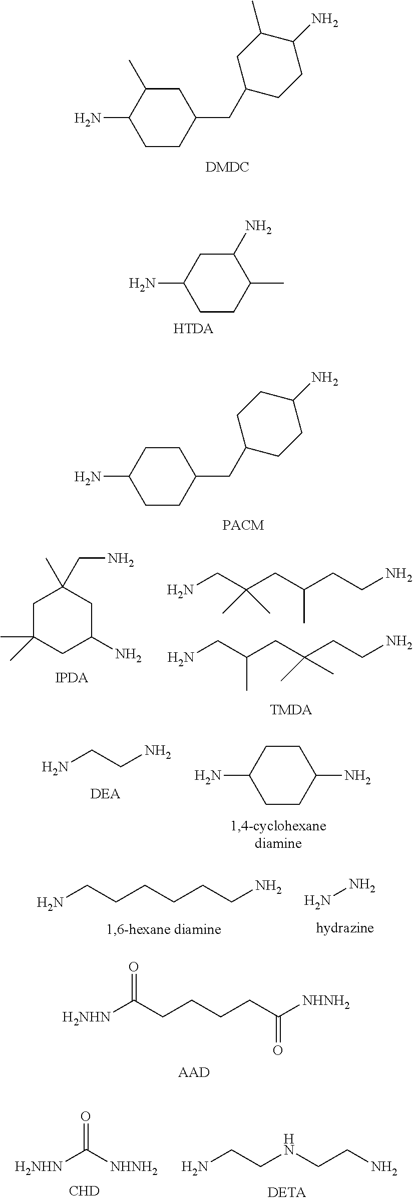

There are also other alkyl diamines (other than 1,6-hexane diamine) that can be uses, such as, by way of example:

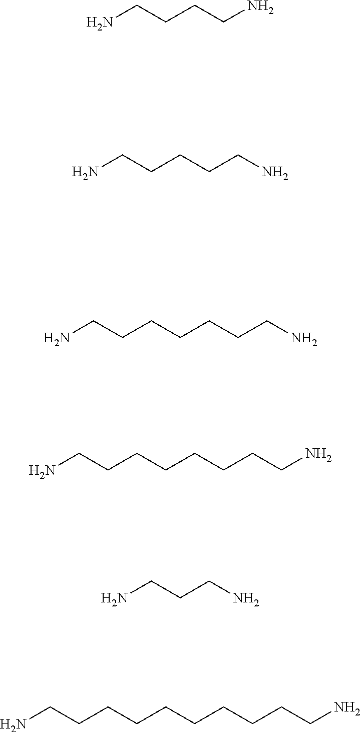 [SMILES: NCCCCN ; NCCCCCN ; NCCCCCCCN ; NCCCCCCCCN ; NCCCN ; NCCCCCCCCCCN]

There are also other dihydrazides (other than AAD shown above) that can be used, such as, by way of example:

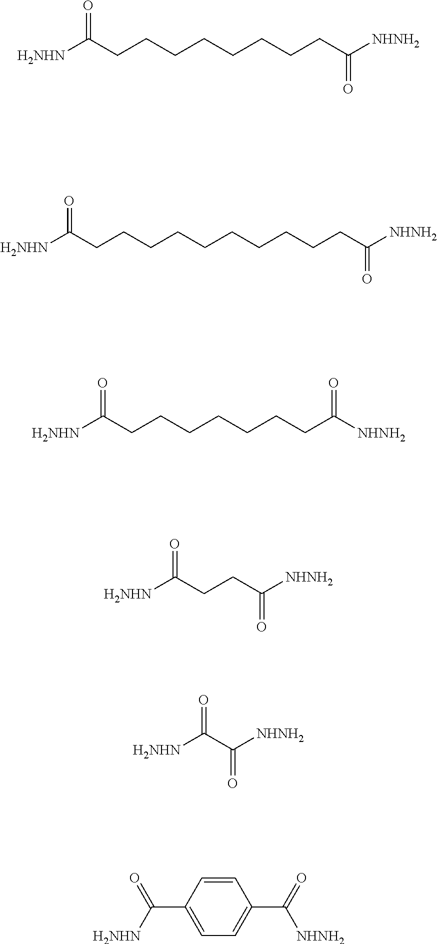

A few example carboxylated- or sulfonated-amines can be in the form of an aliphatic amine sulfonate, e.g., alkyl amine sulfonate, an alicyclic amine sulfonate, or an aliphatic alkyl amine sulfonate, (shown as a sulfonic acid, but as a sulfonate would include a positive counterion associated with an SO₃⁻ group). As another example, the sulfonate group could be replaced with a carboxylate group. An aliphatic amine sulfonate is shown by way of example in Formula I, as follows:

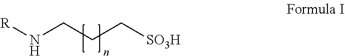

where R is H or is C1 to C10 straight- or branched-alkyl or alicyclic or combination of alkyl and alicyclic, and n is from 0 to 8, for example. Some specific examples of compounds that can be used in accordance with Formula I include the following:

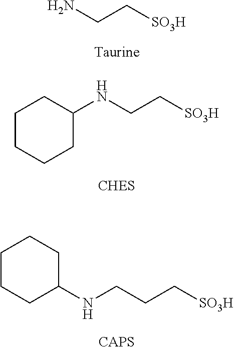 [SMILES: NCCS(=O)(=O)O ; O=S(=O)(O)CCNC1CCCCC1 ; O=S(=O)(O)CCCNC1CCCCC1]

Other examples can include carboxylated- or sulfonated-diamines, such as alkyl amine-alkyl amine-sulfonate as shown in Formula II below. Again, this formula is as a sulfonic acid, but as a sulfonate would include a positive counterion associated with an SO₃⁻ group, or alternatively could be a carboxylate with a counterion, for example). Furthermore, there can be others including those based on many of the diamine structures shown and described above.

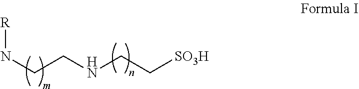

where R is H or is C1 to C10 straight- or branched-alkyl or alicyclic or combination of alkyl and alicyclic, m is 1 to 5, and n is 1 to 5. One example of such a structure sold by Evonik Industries (USA) is A-95, which is exemplified where R is H, m is 1, and n is 1. Another example structure sold by Evonik Industries is Vestamin®, where R is H, m is 1, and n is 2.

In accordance with an example of the present disclosure, after the polyurethane dispersion dispersant is prepared, the polyurethane can be present during the emulsion polymerization of any of a number of latex monomers to form the polyurethane-latex hybrid dispersion or particles. The latex monomers can include (meth)acrylic monomers, in some instances without added or additional surfactants. Example monomers that can be used include (meth)acrylates, such as mono(meth)acrylates, di(meth)acrylates, or polyfunctional alkoxylated or polyalkoxylated (meth)acrylic monomers including one or more di- or tri-(meth)acrylate. Example mono(meth)acrylates include cyclohexyl acrylate, 2-ethoxy ethyl acrylate, 2-methoxy ethyl acrylate, 2(2-ethoxyethoxy)ethyl acrylate, stearyl acrylate, tetrahydrofurfuryl acrylate, octyl acrylate, lauryl acrylate, behenyl acrylate, 2-phenoxy ethyl acrylate, tertiary butyl acrylate, glycidyl acrylate, isodecyl acrylate, benzyl acrylate, hexyl acrylate, isooctyl acrylate, isobornyl acrylate, butanediol monoacrylate, ethoxylated phenol monoacrylate, oxyethylated phenol acrylate, monomethoxy hexanediol acrylate, beta-carboxy ethyl acrylate, dicyclopentyl acrylate, carbonyl acrylate, octyl decyl acrylate, ethoxylated nonylphenol acrylate, hydroxyethyl acrylate, hydroxyethyl methacrylate, or the like. Example polyfunctional alkoxylated or polyalkoxylated (meth)acrylates include alkoxylated, ethoxylated, or propoxylated, variants of the following: neopentyl glycol diacrylates, butanediol diacrylates, trimethylolpropane triacrylates, glyceryl triacrylates, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, polybutanediol diacrylate, polyethylene glycol diacrylate, propoxylated neopentyl glycol diacrylate, ethoxylated neopentyl glycol diacrylate, polybutadiene diacrylate, and the like. In one more specific example, the monomer can be a propoxylated neopentyl glycol diacrylate, such as, for example, SR-9003 (Sartomer Co., Inc., Exton, Pa.). Example reactive monomers are likewise commercially available from, for example, Sartomer Co., Inc., Henkel Corp., Radcure Specialties, and the like.

The reaction medium for preparing the latex core can utilize both a charge stabilizing agent and an emulsifier in order to obtain a target particle size. Various charge stabilizing agents can be suitable for use in preparing the polyurethane-latex hybrid particles of the present compositions. In one example, the charge stabilizing agent can include methacrylic acid, acrylic acid, and/or a salt thereof. Sodium salts of methacrylic acid and/or acrylic acid can likewise be used in generating the (meth)acrylic latex core in the presence of the polyurethane dispersion (which forms the shell). The charge stabilizing agent may be used, for example, at from 0.1 wt % to about 5 wt % of the emulsion polymerization components. Various emulsion polymerization emulsifiers can be used, such as fatty acid ether sulfates, lauryl ether sulfate, etc. The emulsifier can included in amounts such as 0.1 wt % to about 5 wt % by weight of the emulsion polymerization components. The emulsifier can be included not only to obtain the desired particle size of the (meth)acrylic latex core, but further to obtain a desired surface tension of the latex core in the range of from 40 dynes/cm to 60 dynes/cm, for example. In one example, the (meth)acrylic latex core can have a surface tension of from 45 dynes/cm to 55 dynes/cm. The emulsion polymerization can be carried out as a semi-batch process in some examples.

The (meth)acrylic latex core can be synthesized by free radical initiated polymerization, and any of a number of free radical initiator can be used accordingly. In one example, the initiator can include a diazo compound, a persulfate, a per-oxygen, or the like. For example, thermal initiators can be used that include azo compounds, such as 1,1′-azobis(cyclohexanecarbonitrile) 98 wt %, azobisisobutyronitrile 12 wt % in acetone, 2,2′-azobis(2-methylpropionitrile) 98 wt %, 2,2′-azobis(2-methylpropionitrile) recrystallized, 99 wt %; inorganic peroxides, such as ammonium persulfate reagent grade, 98 wt %; hydroxymethanesulfinic acid monosodium salt dihydrate; potassium persulfate ACS reagent, ≥99.0 wt %; sodium persulfate reagent grade, ≥98 wt %; dicumyl peroxide 98 wt %; or organic peroxides such as tert-butyl hydroperoxide solution packed in FEP bottles, ˜5.5 M in decane (over molecular sieve 4 Å); tert-butyl hydroperoxide solution 5.0-6.0 M in nonane; tert-butyl peracetate solution 50 wt % in odorless mineral spirits; cumene hydroperoxide technical grade, 80 wt %; 2,5-di(tert-butylperoxy)-2,5-dimethyl-3-hexyne, blend; Luperox® 101 (from Arkema, France), 2,5-bis(tert-butylperoxy)-2,5-dimethylhexane technical grade, 90 wt %; Luperox® 101XL45, 2,5-bis(tert-butylperoxy)-2,5-dimethylhexane, blend with calcium carbonate and silica; Luperox® 224, 2,4-pentanedione peroxide solution ˜34 wt % in 4-hydroxy-4-methyl-2-pentanone and N-methyl-2-pyrrolidone; Luperox® 231, 1,1-bis(tert-butylperoxy)-3,3,5-trimethylcyclohexane 92 wt %; Luperox® 331M80, 1,1-bis(tert-butylperoxy)cyclohexane solution ˜80 wt % in odorless mineral spirits; Luperox® 531M80, 1,1-bis(tert-amylperoxy)cyclohexane solution ˜80 wt % in odorless mineral spirits; Luperox® A70S, benzoyl peroxide 70 wt %, remainder water; Luperox® A75, benzoyl peroxide 75 wt %, remainder water; Luperox® A75FP, benzoyl peroxide, 75 wt % remainder water contains 25 wt % water as stabilizer, 75 wt %; Luperox® A75FP, benzoyl peroxide, 75 wt % remainder water contains 25 wt % water as stabilizer, 75 wt %; Luperox® A98, benzoyl peroxide reagent grade, ≥98 wt %; Luperox® AFR40, benzoyl peroxide solution 40 wt % in dibutyl phthalate; Luperox® ATC50, benzoyl peroxide ˜50 wt % in tricresyl phosphate; Luperox® DDM-9, 2-butanone peroxide solution ˜35 wt % in 2,2,4-trimethyl-1,3-pentanediol diisobutyrate; Luperox® DHD-9, 2-butanone peroxide solution ˜32 wt % in phthalate-free plasticizer mixture; Luperox® DI, tert-butyl peroxide 98 wt %; Luperox® P, tert-butyl peroxybenzoate 98 wt %; Luperox® TBEC, tert-butylperoxy 2-ethylhexyl carbonate 95 wt %; Luperox® TBH70X, tert-butyl hydroperoxide solution 70 wt % in H2O. Persulfate initiators such as ammonium persulfate are particularly preferred. The initiator may be included, for example, at from 0.01 wt % to 5 wt %, based on the weight of the emulsion polymerization components.

The (meth)acrylic latex core can have a D50 particle size of 20 nm to 140 nm, from 40 nm to 130 nm, from 50 nm to 125 nm, or from 50 nm to 100 nm, for example. The (meth)acrylic latex core can have a glass transition temperature (Tg) from about −30° C. to 50° C., from about −15° C. to 35° C., or from about -5° C. to 35° C. The glass transition temperature of the core can be calculated using the Fox equation, as described herein. In some examples weight average molecular weight of the (meth)acrylic latex core can be from 50,000 Mw to 750,000 Mw, from 50,000 Mw to 600,000 Mw, from 50,000 Mw to 550,000 Mw, from 50,000 Mw to 450,000 Mw, or from 50,000 Mw to 400,000 Mw, or from 75,000 Mw to 750,000 Mw, from 100,000 Mw to 600,000 Mw, or from 200,000 Mw to 550,000 Mw. Molecular weight ranges outside of these ranges can be used. In further detail, the (meth)acrylic latex core can be uncrosslinked, which in some cases can provide comparable durability to crosslinked (meth)acrylic latex cores, which are also included as being usable in accordance with examples of the present disclosure. The term “uncrosslinked” means that the polymer chains are devoid of chemical crosslinkers or crosslinking groups that connect individual polymer strands to one another, which can partially contribute to lower glass transition temperatures in some examples. The term “crosslinked” refers to polymer strands that are interconnected with crosslinking agent or crosslinking groups. Both can be used in accordance with examples of the present disclosure.

Once formed, polyurethane-latex hybrid particles (with the shell applied to the (meth)acrylic latex core) can have a particle size from 50 nm to 150 nm, or from 60 nm to 150 nm, from 75 nm to 150 nm, from 90 nm to 150 nm, from 50 nm to 140 nm, from 75 nm to 140 nm, or from 90 nm to 140 nm, for example. The weight ratio of polyurethane shell to (meth)acrylic latex core can be from 1:19 to 3:7, from 1:10 to 3:7, or from 1:9 to 1:4, from 1:9: to 3:17, or from 3:22 to 7:43, for example. The polyurethane-latex hybrid particles can have a glass transition temperature from −25° C. to 65° C., from −20° C. to 60° C., from −20° C. to 35° C., or from 0° C. to 60° C., for example. Glass transition temperature of the hybrid particles, including both the core and the shell copolymers, can be calculated using the Fox equation, as described herein.

Turning to further detail regarding other components of the ink compositions that can be used for the systems and methods described herein, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-C070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-Y001 yellow pigment dispersion from DIC, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, or about 214, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The term “(meth)acrylate” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylate or a (meth)acrylic acid should not be read so rigidly as to not consider relative pH levels, ester chemistry, and other general organic chemistry concepts.

The ink compositions of the present disclosure can be formulated to include a liquid vehicle, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition used in the systems and methods described herein, the pigment, dispersant, and the polyurethane can be included or carried by the liquid vehicle components. Suitable pH ranges for the ink composition can be from pH 6 to pH 10, from pH 7 to pH 10, from pH 7.5 to pH 10, from pH 8 to pH 10, 6 to pH 9, from pH 7 to pH 9, from pH 7.5 to pH 9, etc.

In further detail regarding the liquid vehicle, the co-solvent(s) can be present and can include any co-solvent or combination of co-solvents that is compatible with the pigment, dispersant, and polyurethane-latex hybrid particles. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1,3-propane diol (EPHD), glycerol, dimethyl sulfoxide, sulfolane, glycol ethers, alkyldiols such as 1,2-hexanediol,and/or ethoxylated glycerols such as LEG-1, etc.

The liquid vehicle can also include surfactant and/or emulsifier. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives used to modify properties of the ink.

In another example, as shown in FIG. 4, an example method of printing textiles is shown at 400, and can include ejecting 410 an ink composition onto a fabric substrate. The ink composition can include from 50 wt % to 95 wt % water, from 4 wt % to 49 wt % organic co-solvent, from 0.5 wt % to 12 wt % pigment, wherein the pigment has a dispersant associated with a surface thereof, and from from 0.5 wt % to 20 wt % polyurethane-latex hybrid particles. The polyurethane-latex hybrid particles can include a polyurethane shell having an acid number from 50 mg KOH/g to 110 mg KOH/g and a (meth)acrylic latex core having a glass transition temperature from −30° C. to 50° C. A weight ratio of polyurethane shell to (meth)acrylic latex core can be from 1:19 to 3:7. In one example, the polyurethane-latex hybrid particles can have a D50 particle size from 50 nm to 150 nm, a weight ratio of polyurethane shell to (meth)acrylic latex core from 1:9 to 1:4, and/or the polyurethane shell has an acid number from 85 mg KOH/g to 110 mg KOH/g. The method can further include curing the ink composition on the fabric substrate at a temperature from 100° C. to 200° C. for from 30 seconds to 5 minutes. In one example, the curing can generate self-crosslinking at the polyurethane shell including at the isocyanate-generated amine groups, if present. In certain examples, the fabric substrate can include cotton, polyester, nylon, or a blend thereof. In another example, jetting can be from a thermal inkjet printhead.

The textile printing systems and methods described herein can be suitable for printing on many types of textiles, such as cotton fibers, including treated and untreated cotton substrates, polyester substrates, nylons, blended substrates thereof, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

As mentioned, in some examples, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

It is notable that the term “fabric substrate” or “fabric media substrate” does not include materials such as any paper (even though paper can include multiple types of natural and synthetic fibers or mixtures of both types of fibers). Fabric substrates can include textiles in filament form, textiles in the form of fabric material, or textiles in the form of fabric that has been crafted into finished article, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

The fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). By measuring OD and/or L*a*b* both before and after washing, ΔOD and ΔE value can be determined, which can be a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the Δvalue. The 1976 standard can be referred to herein as “ΔE_{CIE}.” The CIE definition was modified in 1994 to address some perceptual non-uniformities, retaining the L*a*b* color space, but modified to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (RT) to deal with the problematic blue region at hue angles of about 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used.

When inks printed on various types of fabrics, e.g., cotton, nylon, polyester, cotton/polyester blend, etc., they were exposed to durability challenges, such as washfastness, e.g., five (5) standard washing machine cycles using warm water and a standard clothing detergent (e.g., Tide® available from Proctor and Gamble, Cincinnati, Ohio, USA), acceptable optical density retention of the printed inks can be the result. Additionally, these polyurethanes can also exhibit good stability over time as well as good thermal inkjet printhead performance such as high drop weight, high drop velocity, and acceptable “Turn On Energy” or TOE curve values, with some inks exhibiting good kogation.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the polyurethane shells, the (meth)acrylic latex cores, or the polyurethane-latex hybrid particles disclosed herein. This value can be determined, in one example, by dissolving or dispersing a known quantity of a material in organic solvent and then titrating with a solution of potassium hydroxide (KOH) of known concentration for measurement.

“Glass transition temperature” or “Tg,” can be calculated by the Fox equation: copolymer Td=1/(Wa/(TgA)+Wb(TgB) + . . . ) where Wa=weight fraction of monomer A in the copolymer and TgA is the homopolymer Tg value of monomer A, Wb=weight fraction of monomer B and TgB is the homopolymer Tg value of monomer B, etc. Thus, the glass transition temperature for the polyurethane shell and the (meth)acrylic latex core can both be included in this calculation to determine the glass transition temperature of the polyurethane-latex hybrid as a whole. Alternatively, the glass transition temperature of the polyurethane shell and/or the (meth)acrylic latex core can be calculated alone using the same equation, for example.

“D50” particle size is defined as the particle size at which about half of the particles are larger than the D50 particle size and about half of the other particles are smaller than the D50 particle size (by weight based on the metal particle content of the particulate build material). As used herein, particle size with respect to the latex particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Preparation of Polyurethane Dispersions 1 (PUD-1)

35.458 grams of grams of polytetrahydrofuran 1000 (PTMG), 35.467 grams of isophorone diisocyanate (IPDI), and 10.701 grams of 2,2-bis(hydroxymethyl)propionic acid (DMPA) in 42 grams of acetone were mixed in a 500 mL of 4-neck round bottom flask. A mechanical stirrer with glass rod and Teflon blade and a condenser was attached. The flask was immersed in a constant temperature bath at 60° C. The system was kept under drying tube. 3 drops of dibutyltin dilaurate (DBTDL) was added to initiate the polymerization. Polymerization was continued for 3 hours at 60° C. 0.5 gram samples was withdrawn for NCO titration to confirm the reaction. The measured NCO value was 4.35 wt %. Theoretical w % NCO should be 4.56%. The polymerization temperature was reduced to 40° C. 18.375 grams of 2-(cyclohexylamino)ethansesullfonic acid (CHES), 14.149 grams of 50% NaOH, and 45.937 grams of deionized water were mixed in a beaker until CHES were completely dissolved. The CHES solution was added to the pre-polymer solution at 40° C. with vigorous stirring over 1-3 minutes. The solution became viscous and slight hazy. The mixture continued to be stir for 30 minutes at 40° C. The mixture became clear and viscous after 15-20 minutes at 40° C. 181.938 grams of deionized water was added to the polymer mixture in 4-neck round bottom flask over 1-3 minutes with good agitation to form the polyurethane (PUD) dispersion. The agitation was continued for 60 minutes at 40° C. The PUD dispersion was filtered through 400 mesh stainless sieve. Acetone was removed with a Rotorvap at 50° C., where 2 drops (20 mg) BYK-011 de-foaming agent was added. The final PUD dispersion was filtered through fiber glass filter paper. The D50 particle size was measured by a Malvern Zetasizer at 20.2 nm. The pH was 8.5. The solid content was 29.63 wt %.

### Example 2—Polyurethane Dispersions 2-6 (PUD-2 o PUD-6)

Polyurethane Dispersion 2-6 are prepared using the procedure outlined in Example 1, except that the following ingredients and weight percentages are used as shown in Table 1 below, rather than those outline in Example 1. As a note, the PUD-1 is also included in Table 1 for convenience.

TABLE 1
Polyurethane Dispersions

| | | | | | |
|---|---|---|---|---|---|
| PUD-1 | | | | | |
| (wt %) | PUD-2 | PUD-3 | PUD-4 | PUD-5 | PUD-6 |
| Ex. 1 | (wt %) | (wt %) | (wt %) | (wt %) | (wt %) |

Ingredients

| | | | | | | |
|---|---|---|---|---|---|---|
| Isophorone diisocyanate | 35.47 | 38.25 | 42.17 | 51.68 | 41.55 | 40.96 |
| (IPDA - diisocyanate) | | | | | | |
| 2,2-Bis(hydroxymethyl) | 10.7 | 11.54 | 12.72 | 23.86 | 12.54 | 12.36 |
| propionic acid (DMPA | | | | | | |
| Diamine) | | | | | | |
| 2-(cyclohexylamino) | 18.38 | — | — | — | — | — |
| ethansesullfonic acid | | | | | | |
| (CHES Amino Sulfonate) | | | | | | |
| Isopropyl Alcohol (IPA) | — | — | — | — | — | 6.21 |
| Ethyl Alcohol (EtOH) | — | — | — | — | 4.83 | — |
| Methyl Alcohol (MeOH) | — | — | 3.41 | 0.43 | — | — |
| Taurine | — | 11.97 | — | — | — | — |

PROPERTIES

| | | | | | | |
|---|---|---|---|---|---|---|
| pH | 8.5 | 9 | 8 | 8 | 7.5 | 7.5 |
| Solid content (wt %) | 29.63 | 30.98 | 31.36 | 30.34 | 31.69 | 30.44 |
| D50 Particle Size (nm) | 20.2 | 19.7 | 26.6 | 17.8 | 20.28 | 17.61 |
| Acid Number (mg KOH/g) | 94.5 | 101.9 | 53.2 | 99.8 | 52.4 | 51.7 |
| NCO:OH Molar Ratio | 1.385 | 1.385 | 1.389 | 1.027 | 1.389 | 1.389 |

### Example 3—Preparation of Polyurethane-Latex Hybrid Dispersion 1 (PULH-1)

A suspension of PUD-1 (43.874 g), sodium persulfate (SPS) (0.25 g), sodium dodecyl sulfate (SDS) (2.0 g), butyl acrylate (BA) (18.351 g), and methyl methacrylate (MMA) (76.225 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer at 118.8 nm. The pH was 7.5. The solid content was 34.24 wt %.

### Example 4—Preparation of Polyurethane-Latex Hybrid Dispersion 2 (PULH-2)

A suspension of PUD-1 (43.874 g), sodium persulfate (SPS) (0.25 g), sodium dodecyl sulfate (SDS) (2.0 g), methacrylamide (MAA) (1.692 g), butyl acrylate (BA) (18.351 g) and methyl methacrylate (MMA) (76.225 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 125.2 nm. The pH was 7.5. The solid content was 32.65 wt %.

### Example 5—Preparation of Polyurethane-Latex Hybrid Dispersion 3 (PULH-3)

A suspension of PUD-1 (43.874 g), sodium persulfate (SPS) (0.759 g), sodium dodecyl sulfate (SDS) (2.0 g), methacrylamide (MAA) (1.692 g), 1,3-butanediol dimethacrylate (1,3-BDDMA) (1.25 g), butyl acrylate (BA) (14.715 g) and methyl methacrylate (MMA) (68.92 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 Particle size measured by a Malvern Zetasizer was 115.2 nm. The pH was 7.5. The solid content was 30.55 wt %.

### Example 6—Preparation of Polyurethane-Latex Hybrid Dispersion 4 (PULH-4)

A suspension of PUD-1 (43.874 g), sodium persulfate (SPS) (0.759 g), sodium dodecyl sulfate (SDS) (2.0 g), methacrylamide (MAA) (1.357 g), 1,3-butanediol dimethacrylate (1,3-BDDMA) (2.50 g), butyl acrylate (BA) (14.715 g) and methyl methacrylate (MMA) (68.75 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 Particle size measured by a Malvern Zetasizer was 107.5 nm. The pH was 7.5. The solid content was 30.98 wt %.

### Example 7—Preparation of Polyurethane-Latex Hybrid Dispersion 5 (PULH-5)

A suspension of PUD-1 (43.874 g), sodium persulfate (SPS) (0.125 g), sodium dodecyl sulfate (SDS) (2.0 g), butyl acrylate (BA) (18.351 g) and methyl methacrylate (MMA) (76.225 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 114.7 nm. The pH was 7.5. The solid content was 33.58 wt %.

### Example 8—Preparation of Polyurethane-Latex Hybrid Dispersion 6 (PULH-6)

A suspension of PUD-1 (43.874 g), sodium persulfate (SPS) (0.947 g), methacrylamide (MAA) (1.692 g), sodium dodecyl sulfate (SDS) (2.0 g), butyl acrylate (BA) (30.000 g) and methyl methacrylate (MMA) (65.000 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 113.5 nm. The pH was 7.0. The solid content was 34.33 wt %.

### Example 9—Preparation of Polyurethane-Latex Hybrid Dispersion 7 (PULH-7)

A suspension of PUD-1 (43.874 g), sodium persulfate (SPS) (0.947 g), methacrylamide (MAA) (1.692 g), sodium dodecyl sulfate (SDS) (2.0 g), butyl acrylate (BA) (35.0 g) and methyl methacrylate (MMA) (60.0 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 138.7 nm. The pH was 7.0. The solid content was 36.49 wt %.

### Example 10—Preparation of Polyurethane-Latex Hybrid Dispersion 8 (PULH-8)

A suspension of PUD-1 (43.874 g), sodium persulfate (SPS) (0.947 g), methacrylamide (MAA) (1.692 g), sodium dodecyl sulfate (SDS) (2.0 g), butyl acrylate (BA) (45.0 g) and methyl methacrylate (MMA) (55.0 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 99.51 nm. The pH was 6.5. The solid content was 34.19 wt %.

### Example 11—Preparation of Polyurethane-Latex Hybrid Dispersion 9 (PULH-9)

A suspension of PUD-1 (43.874 g), sodium persulfate (SPS) (0.25 g), sodium dodecyl sulfate (SDS) (2.0 g), butyl acrylate (BA) (50.0 g) and methyl methacrylate (MMA) (50.0 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 112.4 nm. The pH was 6.5. The solid content was 34.83 wt %.

### Example 12—Preparation of Polyurethane-Latex Hybrid Dispersion 10 (PULH-10)

A suspension of PUD-1 (43.874 g), sodium persulfate (SPS) (0.915 g), sodium dodecyl sulfate (SDS) (2.0 g), reactive monomer (HA) (2.212 g), butyl acrylate (BA) (17.729 g) and methyl methacrylate (MMA) (73.667 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 132.8 nm. The pH was 6.5. The solid content was 31.24 wt %.

### Example 13—Preparation of Polyurethane-Latex Hybrid Dispersion 11 (PULH-11)

A suspension of PUD-1 (43.874 g), sodium persulfate (SPS) (0.915 g), sodium dodecyl sulfate (SDS) (2.0 g), reactive monomer (CX-650) (1.692 g), butyl acrylate (BA) (17.729 g) and methyl methacrylate (MMA) (73.667 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 137.9 nm. The pH was 6.5. The solid content was 30.6 wt %.

### Example 14—Comparative Properties of Polyurethane-latex Hybrid Particles 1-11 (PULH-1 to PULH-11)

Table 2 below provides comparative properties regarding PULH-1 to PULH-11 particles, as follows:

TABLE 2
Properties of Polyurethane-latex Hybrid Dispersion or Particles

| | Tg of | | | | | |
|---|---|---|---|---|---|---|
| | Latex | Weight | Particle | Weight Average | | Crosslinked |
| PULH | Core | Ratio | Size | Molecular | | Core |
| ID | (° C.) | (PU:Latex) | (nm) | Weight (Mw) | pH | (Y or N) |
| PULH-1 | 60 | 3:22 | 118.8 | 450,000 | 7.5 | N |
| PULH-2 | 60 | 3:22 | 125.2 | 450,000 | 7.5 | N |
| PULH-3 | 55 | 7:43 | 115.2 | 500,000 | 7.5 | Y |
| PULH-4 | 50 | 7:43 | 107.5 | 500,000 | 7.5 | Y |
| PULH-5 | 60 | 3:22 | 114.7 | 420,000 | 7.5 | N |
| PULH-6 | 30 | 3:22 | 113.5 | 300,000 | 7.0 | N |
| PULH-7 | 28 | 3:22 | 138.7 | 350,000 | 7.0 | N |
| PULH-8 | 12 | 3:22 | 99.51 | 250,000 | 6.5 | N |
| PULH-9 | −16 | 3:22 | 112.4 | 260,000 | 6.5 | N |
| PULH-10 | 50 | 13:87 | 132.8 | 390,000 | 6.5 | Y |
| PULH-11 | 50 | 13:87 | 137.9 | 460,000 | 6.5 | Y |

### Example 15—Ink Compositions

Ink Compositions were prepared using polyurethane-latex hybrid dispersions prepared in accordance with Examples 3-13, and shown by comparison in Table 3 of Example 14. The ink compositions were formulated as follows:

TABLE 3
Ink Compositions

| | | Amount |
|---|---|---|
| Ingredients | Category | (wt %) |
| Glycerol | Organic Co-solvent | 6 |
| LEG-1 | Organic-Co-solvent | 1 |
| Crodafos ® N3 Acid | Surfactant | 0.5 |
| Surfynol ® 440 | Surfactant | 0.3 |
| Acticide ® B20 | Biocide | 0.22 |
| Polyurethane-Latex Hybrid Particles | Binder | 6 |
| Magenta Pigment (dispersed with | Colorant | 3 |
| styrene-acrylic polymer dispersant) | | |
| Water | Solvent | Balance |

Crodafos ™ is available from Croda ® International Plc. (Great Britain).
Surfynol ® is available from Evonik, (Canada).
Acticide ® is available from Thor Specialties, Inc. (USA).

### Example 15—Heat-Cured Ink Composition Durability on Fabric Substrates

Several prints were prepared by applying the magenta ink composition of Table 3 as durability plots at 3 dots per pixel (dpp) on fabric substrates, which in this example was a gray cotton fabric substrate. After printing, the ink compositions were cured on the respective fabrics at 150° C. for 3 minutes. After curing, initial optical densities (OD) and L*a*b* values were recorded, the various printed fabrics were exposed to 5 washing machine complete wash cycles using conventional washing machines at 40° C. with detergent, e.g., Tide®, with air drying in between wash cycles. After 5 washes, the OD and L*a*b* were recorded a second time for comparison, as shown in Table 4 below.

TABLE 4
Durability of Magenta Ink Composition printed
and Heat-Cured on Cotton Gray Fabric Substrate

| | |
|---|---|
| PULH ID | 150° C. Curing |

| in Ink | Initial OD | OD 5 wash | %ΔOD | ΔE_{CIE} |
|---|---|---|---|---|
| PULH-1 | 0.803 | 0.773 | −0.030 | 1.968 |
| PULH-5 | 0.798 | 0.786 | −0.012 | 1.882 |
| PULH-6 | 0.778 | 0.766 | −0.012 | 1.425 |
| PULH-7 | 0.826 | 0.791 | −0.034 | 2.445 |
| PULH-8 | 0.789 | 0.792 | −0.004 | 1.215 |
| PULH-9 | 0.808 | 0.798 | −0.012 | 1.743 |

As can be seen from the data collected above, most of the latex-based ink compositions printed on gray cotton fabric substrate showed good durability even without external crosslinkers, with a few showing excellent durability which is similar to commercially available Jantex™ polymers, available from JANTEX INKS, (USA), which includes melamine crosslinkers that can be toxic. The latex core can provide added durability, even when not crosslinked as was the case with the various (meth)acrylic latex cores evaluated for durability and shown in Table 4. Several of the polyurethane-latex hybrid particles even showed excellent durability on the gray cotton substrate with a ΔE of less than 2, with only one showing slightly less durability with a ΔE just above 2. It is noted that in some examples, though uncrosslinked polyurethane-latex hybrid particles were evaluated in Table 4, some polyurethane-latex hybrid particles with crosslinked cores, as prepared as shown in Table 2, can also provide good or excellent durability. In further detail, it is noted that the polyurethane-latex hybrid particles in these examples individually had a weight ratio of about 3:22 polyurethane shell to latex core, which is well within the range of 1:19 to 3:7 described herein.

### Example 16—Ink Composition Printability Performance

The various ink compositions which included the latex particles identified in Table 5 below were evaluated for performance from a thermal inkjet pen (A3410, available from HP, Inc.). The data was collected according to the following procedures:

Decap is determined using the indicated time (1 second or 7 seconds) where nozzles remain open (uncapped), and then the number of lines missing during a print event are recorded. Thus, the lower the number the better for decap performance

Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value.

Drop Weight (DW) is an average drop weight in nanograms (ng) across the number of nozzles fired measured using a burst mode or firing at 0.75 Joules.

Drop Weight 2,000 (DW 2K) is measured using a 2-drop mode of firing, firing 2,000 drops and then measuring/calculating the average ink composition drop weight in nanograms (ng).

Drop Volume (DV) refers to an average velocity of the drop as initially fired from the thermal inkjet nozzles.

Decel refers to the loss in drop velocity after 5 seconds of ink composition firing.

Turn On Energy (TOE) Curve refers to the energy used to generate consistent ink composition firing.

TABLE 5
Thermal Inkjet Print Performance

| | | | % | | | | | |
|---|---|---|---|---|---|---|---|---|
| PULH ID | Decap | Decap | Missing | DW | DW 2K | DV | | |
| in Ink | (1 s) | (7 s) | Nozzles | (ng) | (ng) | (m/s) | Decel | TOE Curve |
| PULH-1 | 14 | 24 | 0.0 | 11.2 | 11.9 | 9.4 | 0 | Good |
| PULH-2 | 18 | 24 | 3.1 | 11.0 | 11.9 | 9.3 | 0 | Good |
| PULH-3 | 16 | 27 | 3.1 | 11.1 | 11.5 | 9.0 | 0 | Good |
| PULH-4 | 16 | 28 | 0.0 | 10.8 | 11.9 | 9.4 | 0 | Good |
| PULH-5 | 12 | 21 | 0.0 | 10.9 | 11.9 | 9.7 | 0 | Good |
| PULH-6 | 15 | 25 | 5.2 | 9.8 | 11.8 | 7.6 | 0 | Acceptable |
| | | | | | | | | (Low DW) |
| PULH-7 | 18 | 35 | 0.0 | 11.1 | 10.6 | 9.6 | 0 | Acceptable |
| PULH-8 | 21 | 50 | 3.1 | 9.9 | 11.6 | 7.7 | 0 | Acceptable |
| | | | | | | | | (Low DW) |
| PULH-9 | 19 | 43 | 3.1 | 11.4 | 11.2 | 9.6 | 0 | Acceptable |
| PULH-10 | 121 | 28 | 3.1 | 11.1 | 12.4 | 9.7 | 0 | Good |
| PULH-11 | 10 | 25 | 1 | 11.2 | 11.8 | 9.7 | 0 | Good |
| Impranil ® | 12 | 20 | 0.0 | 12.5 | 7.8 | 12.9 | 0 | Good |
| DLN-SD | | | | | | | | |

As can be seen in Table 5, all of the polyurethane-latex hybrid particles in ink composition showed reasonable or good print performance from a thermal inkjet printhead using varied testing protocols. Some of the ink compositions had acceptable TOE Curve data, but in two cases, the drop weight was lower than with respect to the other inks, for example. TOE Curve data is considered Acceptable or Good when lower levels of energy are used to achieve higher drop weights (DW) as measured in nanograms (ng). For example, achieving a drop weight (DW) of 9.5 ng or above at an energy level 0.75 Joule may be considered “Good” TOE (with DW getting larger with more energy input until the curve flattens out). Achieving a drop weight (DW) of 5.0 ng or above at an energy level 0.75 Joule may be considered “Acceptable” TOE (with DW getting larger with more energy input until the curve flattens out). In further detail, however, lower drop weights (DW) below 9.5 ng or even below 5 ng at 0.75 Joules may provide for a “Good” TOE as long as the drop weights continue to get larger as the energy increases and then flatten out at an acceptable drop weight Achieving a drop weight below 5.0 ng at an energy level of 0.75 Joule may be considered “Good” TOE (with DW getting larger with more energy input until the curve flattens out, as long as the drop weight is acceptable for inkjet printing applications).

While the present technology has been described with reference to certain examples, those skilled in the art will appreciate that various modifications, changes, omissions, and substitutions can be made without departing from the disclosure. It is intended, therefore, that the disclosure be limited only by the scope of the following claims.

What is claimed is:

1. A textile printing system, comprising:
an ink composition, including:
from 50 wt % to 95 wt % water,
from 4 wt % to 49 wt % organic co-solvent,
from 0.5 wt % to 12 wt % pigment, wherein the pigment has a dispersant associated with a surface thereof, and
from 0.5 wt % to 20 wt % polyurethane-latex hybrid particles, the polyurethane-latex hybrid particles including a polyurethane shell having an acid number from 50 mg KOH/g to 110 mg KOH/g and a (meth)acrylic latex core having a glass transition temperature from −30° C. to 50° C., wherein a weight ratio of polyurethane shell to (meth)acrylic latex core is from 1:19 to 3:7; and
a fabric substrate.

2. The textile printing system of claim 1, wherein the polyurethane shell includes isocyanate-generated amine groups along a backbone of the polyurethane.

3. The textile printing system of claim 1, wherein the polyurethane-latex hybrid particles have a D50 particle size from 50 nm to 150 nm.

4. The textile printing system of claim 1, wherein the polyurethane-latex hybrid particles have a weight ratio of polyurethane shell to (meth)acrylic latex core from 1:9 to 1:4.

5. The textile printing system of claim 1, wherein the (meth)acrylic latex core has an acid number from 0 mg KOH/g to less than 50 mg KOH/g, and the polyurethane shell has an acid number from 85 mg KOH/g to 110 mg KOH/g.

6. The textile printing system of claim 1, wherein the (meth)acrylic latex core is uncrosslinked.

7. The textile printing system of claim 1, wherein the (meth)acrylic latex core is has a weight average molecular weight of 50,000 Mw to 750,000 Mw.

8. The textile printing system of claim 1, wherein the polyurethane-latex hybrid particles have a glass transition temperature from −15° C. to 65° C.

9. The textile printing system of claim 1, wherein the fabric substrate includes cotton, polyester, nylon, silk, or a blend thereof.

10. The textile printing system of claim 1, wherein the (meth)acrylic latex core includes copolymerized acrylic amides, copolymerized diacrylates, or a combination thereof.

11. A method of textile printing, comprising ejecting an ink composition onto a fabric substrate, wherein the ink composition comprises:
from 50 wt % to 95 wt % water;
from 4 wt % to 49 wt % organic co-solvent;
from 0.5 wt % to 12 wt % pigment, wherein the pigment has a dispersant associated with a surface thereof; and
from 0.5 wt % to 20 wt % polyurethane-latex hybrid particles, the polyurethane-latex hybrid particles including a polyurethane shell having an acid number from 50 mg KOH/g to 110 mg KOH/g and a (meth)acrylic latex core having a glass transition temperature from −30° C. to 50° C., wherein a weight ratio of polyurethane shell to (meth)acrylic latex core is from 1:19 to 3:7.

12. The method of claim 11, wherein the polyurethane-latex hybrid particles have a D50 particle size from 50 nm to 150 nm, a weight ratio of polyurethane shell to (meth)acrylic latex core from 1:9 to 1:4, and the polyurethane shell has an acid number from 85 mg KOH/g to 110 mg KOH/g.

13. The method of claim 11, further comprising curing the ink composition on the fabric substrate at a temperature from 100° C. to 200° C. for from 30 seconds to 5 minutes.

14. A textile printing system, comprising:
a fabric substrate;
an inkjet printer to eject an ink composition on the fabric substrate, the ink composition, comprising:
from 50 wt % to 95 wt % water,
from 4 wt % to 49 wt % organic co-solvent,
from 0.5 wt % to 12 wt % pigment, wherein the pigment has a dispersant associated with a surface thereof, and
from 0.5 wt % to 20 wt % polyurethane-latex hybrid particles, the polyurethane-latex hybrid particles including a polyurethane shell having an acid number from 50 mg KOH/g to 110 mg KOH/g and a (meth)acrylic latex core having a glass transition temperature from −30° C. to 50° C., wherein a weight ratio of polyurethane shell to (meth)acrylic latex core is from 1:19 to 3:7; and
a heat curing device to apply heat to the ink composition after application onto the fabric substrate.

15. The textile printing system of claim 14, the heat curing device to apply heat a temperature from 100° C. to 200° C. for a period of 30 seconds to 5 minutes.
